(19) United States
(12) Patent Application Publication
(10) Pub. No.: US 2002/0064019 A1
(43) Pub. Date: May 30, 2002

(54) Cathode electrode material and rotating cathode drum for electrolytic copper foil production using the same

(76) Inventors: Makoto Dobashi, Ageo-shi (JP); Sakiko Taenaka, Ageo-shi (JP); Naotomi Takahashi, Ageo-shi (JP); Nobuyoshi Kasahara, Ageo-shi (JP)

Correspondence Address: JENKENS & GILCHRIST, P.C., 225 WEST WASHINGTON, SUITE 2600, CHICAGO, IL, 60606, US

(21) Appl. No.: 09/927,803

(22) Filed: Aug. 10, 2001

(30) Foreign Application Priority Data
Aug. 11, 2000 (JP) 2000-244178

(51) Int. Cl. H01G 4/35

(52) U.S. Cl. 361/302

(57) ABSTRACT

To provide a cathodic electrode material widely applicable to electro winning of a metal, easy in maintenance and capable of producing a deposited metal good in physical properties and shapes. For this purpose, a cathodic electrode material used for electrolytic deposition of a metal, characterized in that the cathodic electrode is made of titanium and the surface on which a metal is electrolytically deposited is provided with a ceramic layer is used. Furthermore, applying this cathodic electrode material to a cathode used for production of an electrolytic copper foil permits an electrolytic copper foil excellent in quality to be obtained.

### FIELD OF THE INVENTION

The present invention relates to a cathode electrode used in a rotating cathode drum for electrolytic copper foil production.

### RELATED BACKGROUND ART

Generally, a so-called electrolytic copper foil often signifies one produced via an electrolytic process and a surface treatment process. This electrolytic copper foil is principally used as a basic material for printed wiring board fabrication used in the electric and electronic industry.

In a common electrolytic copper producing process, the following approach has been adopted. The production of an electrolytic copper foil (strictly referred to as “bulk copper layer” of an electrolytic copper foil in some cases if the electrolytic copper foil after the completion of surface treatment is regarded as the standard) comprises depositing copper on the surface of a cathode drum by use of electrolytic reaction while allowing a copper electrolytic solution such as copper sulfate solution to flow between a drum-shaped rotating cathode (hereinafter, referred to as “rotating cathode drum” ) and a lead-based anode oppositely provided along the shape of the rotating cathode drum so that the deposited copper turns into a foil state and this copper foil is peeled and wound continuously from the rotating cathode drum. This aspect can be seen from FIG. 2 shown schematically. In the present specification, the copper foil at this stage is to be referred to as “electrolytic copper foil.” The electrolytic copper foil in this stage has undergone no surface treatment such as rust-proof treatment and the electrolytic copper foil immediately after electrolytic deposition is in such an activated state as being easily connected to oxygen in air and very likely to being oxidized.

Because of becoming the surface transcribed from the surface shape of a mirror face finished rotating cathode drum and providing a shiny and smooth surface, the surface peeled from a state of this electrolytic copper foil in contact with the rotating cathode drum is generally referred to as shiny side. In contrast, because of being different in the crystal growth rate of deposited copper for every crystal plane, the surface shape of an electrolytic copper foil at the deposition side manifests a mountain-like uneven shape and is generally referred to as matte side. This matte side is used as the surface stuck to an insulating material in producing a copper clad laminate.

Next, this electrolytic copper foil is subjected to nodular treatment and rust-proof treatment by the surface treatment process. Here, a copper foil brought through the surface treatment process is referred to as “treated copper foil.” The nodular treatment applied to a matte surface means preventing the falling separating of copper microparticles by allowing a current to flow under conditions of so-called baking plating in a solution of copper sulfate or the like, depositing copper microparticles onto a mountain-shaped unevenness of a matte side and at once plating in a current range under conditions of level plating. In case of processing to a copper clad laminate in this manner, copper microparticles of a treated copper foil intrude into the insulating resin layer, thus showing a so-called anchor effect. Accordingly, the matte side with copper microparticles deposited is to be referred to as “nodularly treated side.”

In the surface treatment process, metal plating of zinc, a zinc alloy and chrome or rust-proofing with an organic agent using benzotriazole, imidazole or the like is carried out, dried and wound, thereby finishing a treated copper foil as a product.

The basic required quality can be considered to be roughly divided into (1) physical properties of an electrolytic copper foil such as tensile strength, elongation, hardness and ductility and (2) posterior requirements such as peel strength, etching performance, resist adhesion properties and solderability in applications of an electrolytic copper foil to a printed wiring board. In case of an electrolytic copper foil, characteristics determined by its electrolysis process and ones determined by its surface treatment process must be considered separately to satisfy these required characteristics.

However, the characteristics belonging to the above group (1) relate to an electrolytic copper foil obtained principally by electrolysis of a copper sulfate solution and are determined almost by physical properties produced by the electrolysis process before the surface treatment. In contrast, most of those belonging to the above (2) group are factors depending on the combination of shapes such as surface roughness in a state of deposited crystals of an electrolytic copper foil before the surface treatment, produced in the electrolysis process and conditions in the surface treatment process and need a very delicate control.

Namely, one example is taken to make a description. If a profile of the matte side of an electrolytic copper foil is not even and dispersed, the current concentration occurred in a protrudent uneven portion at the stage of deposition of copper microparticles on the matte side to form a roughed surface in the surface treatment process, thereby causing an abnormal growth of copper microparticles and also leading to the treatment transfer in an extreme case in which the copper microparticle part was not removed at the time of etching and remained.

Thus, among the makers of electrolytic copper foils, a great task has always been present of controlling the physical properties of an electrolytic copper foil produced in the electrolysis process to stabilize the matte form of the electrolytic copper foil in a fixed shape. Accordingly, as physical properties of an electrolytic copper foil, multifarious factors such as electrode material, solution composition and electrolytic current have provided the object of control in view of depositing conditions of copper.

For rotating cathode drums as cathode materials, chrome-plated stainless steel or titanium materials have been used according to the rough classification. The Tafel slope of a polarization curve at the time of power polarization depends on even a change in material quality of electrode materials, so that the deposition efficiency in copper electrolysis is greatly affected. Besides, materials used as cathodic electrodes may greatly affect the crystal structure of deposited copper according to how the deposited site of copper is present.

On the other hand, in the production of an electrolytic copper foil, since a long-time electrolysis was carried out using a copper sulfate solution by the continuous power application, the deposition state of copper became uneven with the continuance of use due to formation of a cathode-polarized surface of a rotating cathode drum and metal halide in case of a titanium drum. When the deposition state came out of the management level of an electrolytic copper foil, the rotating cathode drum was taken out once from the electrolytic bath and the re-polishing operation became necessary, so that the management and maintenance cost of this rotating cathode drum has required a great amount of expenses.

Thus, an electrode material easy in maintenance and capable of yielding a good electrolytic copper foil from the viewpoint of physical properties and shapes has been desired.

### BRIEF DESCRIPTION OF THE DRAWINGS

FIG. 1 shows scanning electron microscope observation images of the matte side of an electrolytic copper foil; and

FIG. 2 is a schematic view showing an apparatus for producing an electrolytic copper foil.

### SUMMARY OF THE INVENTION

Such being the case, as a result of zealous and assiduous studies, the present inventors improved the surface state of a titanium made rotating cathode drum into another material quality than the presence state of an ordinary oxide coat to achieve the life prolongation of a titanium made rotating cathode drum and at the same time has thought of a cathode electrode material capable of a copper foil having as stable physical properties and as good uneven a shape of the matte side as ever observed. Incidentally, electrode materials will be described below, which description centers on their application to an electrode copper foil, but their use as electrode materials for the electro refining method of other metals such as zinc applicable to electro winning is also possible.

In elaborating the invention described in the present specification, the preventors considered as following. The titanium-made rotating cathode drum is a rotating drum in which the cathode side with copper deposited thereon is made of titanium. And, this titanium material is light in weight and is known as a metallic material by far exceeding stainless steel in corrosion resistance including acid resistance. The corrosion resistant performance of this titanium material originates in the oxide coat formed on the surface of titanium, which is usually present as a rutile-type or anatase-type composite oxide coat.

A titanium-made rotating drum of this state is used as the cathode in the production of an electrolytic copper foil. Thus, the titanium-made rotating drum is considered to undergo cathode polarization in a copper electrolytic solution and reduction of the oxide coat, so that the initial oxide coat thinned down with the lapse of power application time. And, on the cathode-polarized surface of a titanium-made rotating cathode drum, a slight amount of generated hydrogen is observed. As a result, the titanium electrode, also known as absorber of hydrogen, absorbs part of the generated hydrogen, which thus is trapped in the shape of a titanium halide inside the crystal. According as this hydrogen occlusion advances, the surface of the titanium-made rotating cathode drum becomes unable to maintain the original surface roughness. When such phenomena occur, the above-mentioned glossy surface roughness of the electrolytic copper foil becomes unable to be accommodated within a fixed range.

As far as an ordinary titanium material is used, such phenomena are an inevitable problem and these problems have been coped with by using approaches such as a periodic buff grinding of the surface of a titanium-made rotating cathode drum. To make a titanium-made rotating cathode drum better in corrosion resistance and capable of effective suppression for the hydrogen occlusion with the mention made heretofore placed on premise, the inventors consider the provision of a ceramic layer on the titanium surface.

Further, in case of a stainless-steel-made rotating cathode drum, chromium plating has been applied to protect an electrode surface thereof against corrosion caused by copper sulfate solution which is to be used for manufacturing an electrodeposited copper foil. A stainless-steel-made rotating cathode drum which is hardly affected by occluded hydrogen has to be free from corrosion. To solve the corrosion issue, the present inventors thought of providing a ceramics layer as a means of modifying the surface, which has corrosion resistance and long-term durability both being greater than those of chromium plating. In the following, the present invention will be described.

Claim 1 refers to a cathodic electrode material used for the electrolytic deposition of a metal, characterized in that the cathodic electrode is made of titanium and the electrolytically deposited surface of a metal is equipped with a ceramic layer.

Claim 2 refers to the cathodic electrode material according to claim 1, characterized in that the ceramic layer comprises any of a TiN layer, a TiCN layer, a TiAlN layer, TiCrN layer and a CrN layer.

Since adopting any of a TiN layer, a TiCN layer, a TiAlN layer, a TiCrN layer and a CrN layer is in particular advantageous among the ceramic classified group with the provision of a ceramic layer on a titanium material placed as the premise, the above two inventions are set forth in the scope of claims. If the expression is made simpler, a ceramic layer is formed on the titanium material and this layer is used as a cathodic electrode material. By adopting such a construction, the ceramic layer functions as the barrier to the hydrogen absorption of an underlying titanium material and suppresses the formation of a titanium halide, and moreover it becomes possible to obtain an extremely high anti-corrosion performance in comparison with an ordinary titanium material.

Each TiN, TiCN, TiAlN, TiCrN or CrN layer specifically enumerated here is electrically conductive as good as metals, and provides no special hindrance in use for electrode materials if only having a fixed thickness. Especially, if the current amount in the production of an electrolytic copper foil, the electrolysis of zinc or the like is considered, an extremely great amount of current is loaded and therefore what dominates the deposition rate is thought to be the supply rate of metal ions near the cathodic electrode. Thus, provided the supply amount of an electrolytic solution is sufficient, such electrodes provide no hindrance to the actual operation even if a little poor in conductivity. Here, as far as confirmed through studies, such electrodes is concluded to provide no hindrance whatever if the above ceramic layer is formed within a thickness of 5 μm.

TiN, TiCN, TiAlN, TiCrN, CrN and like layers can be formed on the surface of a titanium material or a stainless steel material by using the sputtering process. A TiN layer and a CrN layer, for example, is formed on a surface layer by the slow leakage of nitrogen gas in the atmosphere and the electron beam irradiation on the surface of a titanium material or a stainless steel material after putting a titanium material or a stainless steel material into the chamber of a sputtering apparatus and setting the interior at a given vacuum degree level. Similarly, by introducing nitrogen gas and organic gases serving as the carbon source into the atmosphere simultaneously, a TiCN layer can be formed on a surface layer. After setting the chamber interior at a given vacuum degree level, a TiAlN layer is formed on a slow leakage of nitrogen gas into the atmosphere and the electron beam irradiation on the surface of a titanium material or a stainless steel material while heating and vaporizing aluminum in the chamber of a sputtering apparatus. A TiCrN layer can be also formed by a method similar to that of a TiAlN layer.

In a case where an ion plating method is employed to form a TiN layer, either titanium material or a stainless steel material is accommodated in the chamber of an ion plating apparatus, vacuum is drawn to a predetermined degree in the chamber and while nitrogen gas is slowly leaked into the atmosphere, direct current is applied between an evaporating source and an electrode for arc to generate arcing, titanium is evaporated for ionizing, and the ionized particles are irradiated onto the surface of a titanium material or a stainless steel material to which negative bias voltage has been applied. A TiCrN layer, TiAlN layer, TiCN layer and CrN layer can be also formed by a method similar to that of forming a TiN layer.

In a metal deposited with this cathodic electrode material used to construct a cathode, the following characteristics are generally observed. (1) The deposited surface is so smooth that an electrolytic deposition excellent in smoothness is performable. (2) The internal strain intrinsic in a deposited metal is small and deformations such as warp or torsion of a deposited metal are slight when the deposited metal is stripped off from an electrode. Even when any metal is electrolyzed and a deposited metal is stripped off and observed, the deposited metal seems to have the above characteristics (1) and (2) in comparison with the case of using a titanium material only.

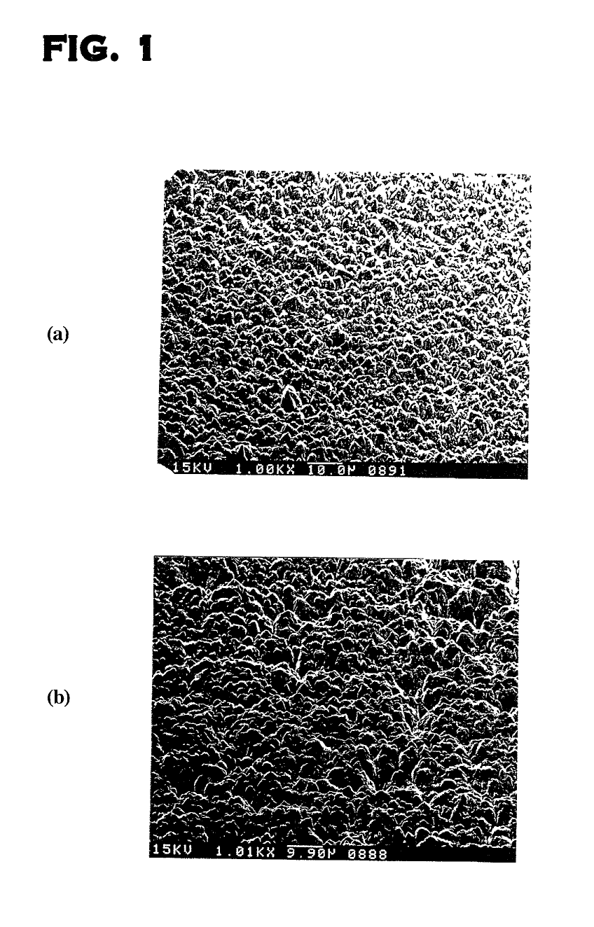

This fact is truly reflected also on the production of an electrolytic copper foil. Namely, in the electrolytic copper foil obtained when produced with a cathodic electrode material according to the present invention employed as the cathode, the uneven roughness of the matte side becomes small, the front tip of this mountain-shaped uneven shape sharpens and moreover the undulation detected if the matte side is regarded as a wide plane area is also reduced in comparison with the case of using a simple titanium material as the cathode. For comparison of this, FIG. 1(a) shows an scanning electron microscope image of the matte side of an electrolytic copper foil produced using a cathodic electrode material according to the present invention and FIG. 1(b) shows an electrolytic copper foil produced using a titanium material simply as the cathode. Contrast of these two scanning electron microscope images discloses the presence of the above-mentioned difference points.

In addition, as a phenomenon considered to reduce the internal strain also at the time of deposition, the degree of curl in an electrolytic copper foil produced with a cathodic electrode foil according to the present invention employed as the cathode is clearly reduced in comparison with the case of using a titanium material simply as the cathode. Here, curl means the maximum value of floating height measured from the plane spanned with four corners of a square when a given size square, e.g. 5 cm square, 10 cm square or the like, of an electrolytic copper foil placed still on a plane with the shinny side directed downward. When a measured value of Curl is indicated in the present specification, the value measured using a 5 cm square sample appears.

On account of the internal strain at the time of deposition derived from the production process, an electrolytic copper foil has a property that the shiny side of the electrolytic copper foil stripped from the cathode side is rolled in the matte side (Curl phenomenon). This Curl phenomenon tends to increase with thinner electrolytic copper foils and a smaller size of measured samples. In cases where lay-up in the press step of copper clad laminate production is automatically executed, this Curl phenomenon may provide a hindrance to a smooth work in the work of automatically chucking and loading an electrolytic copper foil on a pre-preg or the like and a copper foil smaller in Curl has been demanded.

As a result confirmed by the present inventors, comparison made in electrolytic copper foils classified in a nominal thickness of 12 μm and the grade 3 of IPC standard revealed that the Curl measured value of an electrolytic copper foil produced using a cathodic electrode material according to the present invention as the cathode was 2.7 mm and was drastically reduced in comparison with a Curl measured value of 20 mm observed in the case of using a titanium-material simply as the cathode and that a copper foil very good in usability was obtained.

Furthermore, in case of electrolytic copper foils, both elongation and tensile strength seems to improve on the order of approx. 20% in the case of using a titanium material simply as the cathode. For example, electrolytic copper foils classified in a nominal thickness of 12 μm and the grade 3 of IPC standard are compared with physical properties of those produced using a similar electrolytic solution. In the case of using a titanium material simply as the cathode, the elongation as received was 1.8%, the after heating elongation was 5.5%, the dry tensile strength was 43.4 kg/mm² and the after heating tensile strength was 27.7 kg/mm², whereas the elongation as received is 4.2%, the elongation after heating is 11.8%, the dry tensile strength is 53.2 kg/mm² and the tensile strength after heating is 25.2 kg/mm in electrolytic copper foils produced using a cathodic electrode material according to the present invention as the cathode and they are found to be electrolytic copper foils of total balance, well excellent in physical properties.

From these, the present inventors had an idea of applying this electrode material to the production of an electrolytic copper foil. Thus, claim 3 refers to a rotating cathode drum for the production of an electrolytic copper foil using a cathodic electrode according to claim 1 and claim 2.

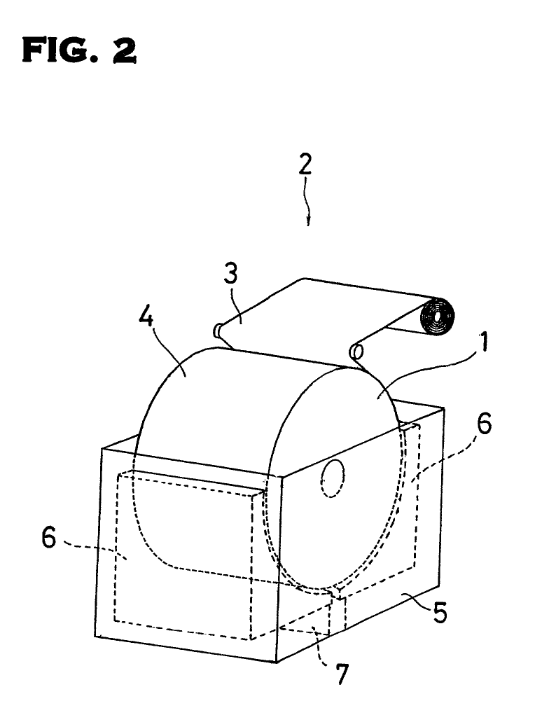

In a rotating cathode drum used in the production of an electrolytic copper foil, as understood from FIG. 2, it is the cylindrical sidewall surface of the rotating cathode drum which serves as the cathodic electrode and this portion comprises a titanium material or a stainless steel material, on whose surface any of a TiN layer, a TiCN layer, a TiAlN layer, a TiCrN layer and a CrN layer is formed as a ceramic layer. The circular wall surface of a rotating cathode drum may be made of other materials such as stainless steel than a titanium material. This is because this surface is not used as the surface on which to deposit copper.

Using a rotating cathode drum of such a construction for the production of an electrolytic copper foil permits a long-term stable use of the rotating cathode drum and eliminates the need for a periodical buff polishing or the like, thus simplifying the process control exceedingly.

### MODES FOR CARRYING OUT THE INVENTION

Referring to FIG. 2, a description is made below. The result of producing a rotating cathode drum 1 by using a cathodic electrode material according to the present invention to construct an electrolytic copper foil production apparatus 2 and to produce an electrolytic copper foil 3 is to be shown as embodiments.

Embodiment 1:

Here, using a titanium material for the cathodic electrode surface 4, a 3 μm thick TiN layer was formed on the titanium material. As the rotating cathode drum of this time, a small-sized one, 8 cm in diameter, with a 5 cm wide cathodic electrode 4 surface was used. A TiN layer was formed by accommodating this rotating cathode drum 1 into an unillustrated sputtering apparatus, evaporating the interior down to a vacuum degree level of the order of 1.22×10⁻³ Pa (1×10⁻⁵ Torr). While nitrogen gas was slowly leaked into the atmosphere, direct current was applied between an evaporating source and an electrode for arc to generate arcing, titanium was evaporated for ionizing, and the ionized particles were irradiated onto the surface of the cathodic electrode 4.

This rotating cathode drum 1 was installed at the electrolytic copper foil production apparatus 2 and a copper sulfate solution was used as the electrolytic solution to accomplish the production of an electrolytic copper foil. Inside the electrolytic bath 5 of the electrolytic copper foil production apparatus 2, a lead anode 6 shaped along the shape of the rotating cathode drum 1 was opposed and disposed apart with a gap provided, a copper sulfate solution was used as the copper electrolytic solution and was allowed to flow from the bottom of the lead anode 6 through a copper sulfate solution supply port 7 into the gap between the rotating cathode drum 1 and the lead anode 6 and to overflow at the top of the lead anode 6 and circulate. The copper sulfate solution used at this time had a copper concentration of 83 g/l, a sulfuric acid concentration of 150 g/l, a glue of 1.0 mg/l and a temperature of 48 to 52° C. Under electrolysis conditions comprising a current density of 78.8 A/dm², electrolysis proceeded while rotating the rotating cathode drum 1 to obtain a 12 μm thick electrolytic copper foil 3.

The Curl measured value of this electrolytic copper foil was 2.3 mm, the elongation as received was 4.6%, the elongation after heating was 12.3%, the dry tensile strength was 52.5 kg/mm² and the tensile strength after heating was 26.3 kg/mm².

Embodiment 2:

In this Embodiment, a stainless steel material was employed for the cathodic electrode surface 4 of the rotating cathode drum 1, and a 3 Mm thick CrN layer was formed on the stainless steel material. The rotating cathode drum used was a small-sized one having a diameter of 8 cm and a cathodic electrode 4 surface with a width of 5 cm. A CrN layer was formed by accommodating this rotating cathode drum 1 into an unillustrated sputtering apparatus, evaporating the interior down to a vacuum degree level of the order of 1.22×10⁻³ Pa (1×10⁻⁵ Torr). While nitrogen gas was slowly leaked into the atmosphere, direct current was applied between a chrome evaporating source and an electrode for arc to generate arcing, chrome was evaporated for ionizing, and the ionized chrome was irradiated onto the surface of the cathodic electrode 4.

This rotating cathode drum 1 was installed at the electrolytic copper foil production apparatus 2 and a copper sulfate solution was used as the electrolytic solution to accomplish the production of a 12 μm thick electrolytic copper foil 3 in a manner similar to that in Embodiment 1.

The Curl measured value of this electrolytic copper foil was 4.3 mm, the elongation as received was 6.1%, the elongation after heating was 11.9%, the dry tensile strength was 50.4 kg/mm² and the tensile strength after heating was 26.1 kg/mm².

### Industrial Applicability

Using a cathodic electrode material according to the present invention permits application not only to an electrolytic copper foil but also to a ordinary copper winning capable of electro winning, the electro winning of zinc and the electrolysis of nickel, iron and the like and enables the deposited metal component to be easily stripped from the cathodic electrode. What is more, since no maintenance is necessary for an extremely long term as cathodic electrode materials, complications involved in the process control becomes solvable and the reduction of production cost considered totally is also achievable.

1. A cathodic electrode material used for electrolytic deposition of a metal, wherein
said cathodic electrode is made of titanium or stainless steel and a surface on which a metal is electrolytically deposited is provided with a ceramic layer.

2. The cathodic electrode material as set forth in claim 1, wherein said ceramic layer is any of a TiN layer, a TiCN layer, a TiAlN layer, a TiCrN layer, and a CrN layer.

3. A rotating cathode drum for electrolytic copper foil production using a cathodic electrode material as set forth in claim 1 or claim 2.
